(19) United States
(12) Patent Application Publication
(10) Pub. No.: US 2009/0191515 A1
(43) Pub. Date: Jul. 30, 2009

(54) METHOD OF PROVIDING AN EATING PLAN HAVING A VERY LOW CONCENTRATION OF NATURAL TOXINS

(75) Inventor: Roy J. Mankovitz, Montecito, CA (US)

Correspondence Address: GIFFORD, KRASS, SPRINKLE,ANDERSON & CITKOWSKI, P.C, PO BOX 7021, TROY, MI, 48007-7021, US

(73) Assignee: Julie K. Staple

(21) Appl. No.: 12/359,655

(22) Filed: Jan. 26, 2009

Related U.S. Application Data
(60) Provisional application No. 61/023,550, filed on Jan. 25, 2008.

(51) Int. Cl. G09B 19/00; A23L 1/304

(52) U.S. Cl. 434/127; 426/74

(57) ABSTRACT

The present invention describes a method of providing an eating plan having a very low concentration of natural toxins is described according to the present invention. In particular embodiments, foods low in synthetic and/or naturally occurring toxins are included in diet protocols for individuals to promote healthy eating. Methods of promoting health are provided according to embodiments of the present invention which include providing a diet protocol to the public, the diet protocol including recommendation of foods low in synthetic and/or naturally occurring toxins which pass the Available Before Civilization Test requiring that the foods 1) are native to Africa; 2) require no human processing, including heating or cooking, to either gain access to, or digest or derive nutrition from the food in its natural form; 3) are not toxic if consumed raw; and 4) are not newly hybridized within the last 125,000 years or genetically modified.

### REFERENCE TO RELATED APPLICATION

This application claims priority from U.S. Provisional Patent Application Ser. No. 61/093,550, filed Jan. 25, 2008, the entire content of which is incorporated herein by reference.

### FIELD OF THE INVENTION

The present invention relates generally to health-promoting diet and methods for promoting healthy eating. In specific embodiments the present invention relates to methods of providing eating plans for diets having very low amounts of toxins.

### BACKGROUND OF THE INVENTION

Numerous diets are constantly touted in the media as a part of a healthy lifestyle. However, extant eating plans pay insufficient attention to the quality of recommended foods. There is a continuing need for diet protocols directed to diets having very low amounts of toxins, particularly naturally occurring toxins.

### SUMMARY OF THE INVENTION

Methods of promoting health are provided according to embodiments of the present invention which include providing a diet protocol to the public, the diet protocol including recommendation of foods low in synthetic and/or naturally occurring toxins which pass the Available Before Civilization Test requiring that the foods 1) are native to Africa; 2) require no human processing, including heating or cooking, to either gain access to, or digest or derive nutrition from the food in its natural form; 3) are not toxic if consumed raw; and 4) are not newly hybridized within the last 125,000 years or Genetically modified.

In preferred embodiments, diet protocols of the present invention wan against consumption of processed meats, dairy products, plant seeds, beans, nuts, tubers, roots, flowers, leaves, purified sugar, artificial sweeteners, vegetable oils extracted from the vegetable source, and liquids other than mineral water and spring water.

Embodiments of he present invention include diet protocols that include foods which pass the Available Before Civilization Test and which are substantially free of protease inhibitors, lectins, glucosinolates, goitrogens, cyanogens, saponins, gossypol pigments, lathyrogens, carcinogens, and estrogen disruptors. The term “substantially free” refers to foods which contain no detectable protease inhibitors, lectins, glucosinolates, goitrogens, cyanogens, saponins, gossypol pigments, lathyrogens, carcinogens, or estrogen disruptors, for example as can be demonstrated using well-known detection methods. Examples of foods low in synthetic and/or naturally occurring toxins and passing the Available Before Civilization Test are organic free range grass-fed meat, organic sweet fruit, unrefined ancient seabed salt, mineral water and soil-based compounds.

Diet packages containing food substantially free of naturally occurring toxins for consumption by one or more humans are provided according to embodiments of the present invention which include at least one type of organic free range grass-fed meat, at least one type of organic sweet fruit, unrefined ancient seabed salt, mineral water and soil-based compounds.

Optionally, diet packages containing food substantially free of naturally occurring toxins for consumption by one or more humans are provided according to embodiments of the present invention which include at least one meal-size portion of an organic free range grass-fed meat; at least one meal-size portion of an organic sweet fruit; at least one meal-size portion of unrefined ancient seabed salt; at least one meal-size portion of mineral water; and at least one meal-size portion of soil-based compounds.

### DETAILED DESCRIPTION OF THE INVENTION

The present invention describes a method of providing an eating plan having a very low concentration of natural toxins is described according to the present invention. In particular embodiments, foods low in synthetic and/or naturally occurring toxins are included in diet protocols for individuals to promote healthy eating.

The term “toxin” as used in herein refers to any substance that causes illness, whether organic or inorganic, and whether originating from outside the body or from inside.

Toxins are known or can be identified using standard methodology, for instance as described in C. Klaassen, Casarett And Doull's Toxicology, McGraw-Hill Professional, 7^{th} Ed., 2007.

Naturally occurring toxins include protease inhibitors, lectins, glucosinolates and other goitrogens, cyanogens, saponins, gossypol pigments, lathyrogens, carcinogens, and estrogen disruptors.

A food substantially free of synthetic and/or naturally occurring toxins is a food in which such toxins are not detectable using standard methods of toxin detection. Levels of naturally occurring and other toxins in a particular food can be determined using standard assay methods, for instance as described in C. Klaassen, Casarett And Doull's Toxicology, McGraw-Hill Professional, 7^{th} Ed., 2007.

In preferred embodiments, foods low in synthetic and/or naturally occurring toxins included in diet protocols of the present invention are foods which pass the “ABC TEST FOR FOOD”™, that is, the “Available Before Civilization Test.”

In order to pass the ABC TEST FOR FOOD™, a food 1) was native to Africa, preferably tropical East Africa, considered the birthplace of our ancestors, and was reachable by a barefoot human; 2) requires no human processing, including heating or cooking, to either gain access to, or digest or derive nutrition from the food in its natural form; 3) is not toxic if consumed raw; and 4) is not newly hybridized or genetically modified, but is as close as possible to the Version that would be available pre-cultivation/domestication and pre-cooking (about more than 125,000 years ago).

Foods low in synthetic and/or naturally occurring toxins and/or which pass the ABC TEST FOR FOOD™ illustratively include, but are not limited to, organic free range grass-fed meat, organic sweet fruit, unrefined ancient seabed salt, mineral water and soil-based compounds.

Additional foods low in synthetic and/or naturally occurring toxins and/or which pass the ABC TEST FOR FOOD™ illustratively include, but are not limited to, those foods which pass the ABC TEST FOR FOOD™ and which are described in the following references, all of which are incorporated herein in their entirety: Ayensu, E. S., and D. G. Coursey. 1972. Guinea Yams Botany, Ethnobotany, Use and Possible Future of Yams in West-Africa. Economic Botany 26:301-318; Basabose, A. K. 2002. Diet composition of chimpanzees inhabiting the montane forest of Kahuzi, Democratic Republic of Congo. American Journal of Primatology 58:1-21; Eckman, K., and D. A. Hines. 1993. Indigenous multipurpose trees of Tanzania: uses and economic benefits for people in C.S.C. a. D.S.F. o. Tanzania, ed. Food and Agriculture Organization of the United Nations, Ottawa, Ontario, Canada; Grivetti, L. E., and B. M. Ogle. 2000. Value of traditional foods in meeting macro- and micronutrient needs: the wild plant connection. Nutrition Research Reviews 13:31-46; Johns, T., E. B. Mhoro, and P. Sanaya. 1996. Food plants and masticants of the Batemi of Ngorongoro District, Tanzania. Economic Botany 50:115-121; Johns, T., E. B. Mhoro, and F. C. Uiso. 1996. Edible plants of Mara Region, Tanzania. Ecology of Food and Nutrition 35:71-80; Lersela, T., E. T. F. Witkowski, and K. Balkwill. 2003. Plant resources used for subsistence in tsehlanyane and Bokong in Lesotho. Economic Botany 57:619-639; Lykke, A. M., M. K. Kristensen, and S. Ganaba. 2004. Valuation of local use and dynamics of 56 woody species in the Sahel. Biodiversity and Conservation 13:1961-1990; Lykke, A. M., O. Mertz, and S. Ganaba. 2002. Food consumption in rural Burkina Faso. Ecology of Food and Nutrition 41:119-153; Mojeremane, W., and S. O. Tshwenyane. 2004. Anzana garckena: A valuable edible indigenous fruit tree of Botswana. Palistan Journal of Nutrition 3:264-267; Pakia, M., and J. A. Cooke. 2003. The ethnobotany of the Midzichenda tribes of the coastal forest areas in Kenya: 1. General perspective and non-medicinal plant uses. South African Journal of Botany 69:370-381; Tabuti, J. R. S. 2007. The uses, local perceptions and ecological status of 16 woody species of Gadumire Sub-county, Uganda. Biodiversity and Conservation 16:1901-1915; Terashima, H., and M. Ichikawa. 2003. A comparative ethobotany of the Mbuti and Efe hunter-gatherers in the Ituri Forest, Democaratic Republic of Congo. African Study Monographs 24:1-168; Vainio-Mattila, K. 2000. Wild vegetables used by the Sambaa in the Usambara Mountains, NE Tanzania. Annales Botanici Fennici 37:57-67; Wilfred, P., S. S. Madoffe, and E. J. Luoga. 2006. Indigenous plant uses and use values in Uluguru Mountains, Morogoro, Tanzania. Journal of East African Natural History 95:235-240; Youngblood, D. 2004. Identification and quantification of edible plant foods in the Upper (Nama) Karoo, South Africa. Economic Botany 58:S43-S65; and Zomlefer, W. B. 1994. Guide to flowering plant families. The University of North Carolina Press, Chapel Hill, N.C. and London.

Preferred meats included in diet protocols provided by the present invention are meats from cattle, buffalo, sheep, pigs, antelope, goats, ostrich and hippopotamus. Blood from such animals is also an acceptable food. Pemmican is a food which passes the ABC TEST FOR FOOD™ and which is included in diet protocols according to the present invention.

Organic raw, sweet, ripe, non-astringent and non-bitter fruits are recommended and are included in diet protocols of the present invention. The fruits included in the diet protocols may have seeds but swallowing or biting into the seeds is not recommended. Examples of such fruits include figs, watermelon, fruit from the ebony tree of genus Diospyros and jujubes from the genus Ziziphus.

Additional fruits included in diet protocols of the present invention are: fruits of the family Anacardiaceae including fruit of Anacardiaceae plants such as Lannea schweinfurthii; Mangifera indica also known as mango; Rhus natalensis; Sclerocarya birrea; Annona senegalensis; Annonidium mannii also known as taku or ebambu; and Uvaria lucida ssp. lucida also known as mudzala-komba or mudzala; fruits of the family Apocynaceae such as fruit of Ancylobotrys petersiana also known as muhonga or mutongazi; Anthoclitandra robustior also known as mangocha or makpodu; Carissa tetramera also known as muloe; Dictyophleba lucida, also known as malondo or mangocha aei; Dictyophleba ochracea also known as ato, aato, or pembilibiti; Landolphia jumellei also known as akuku or ngano; Landolphia kirkii also known as muhonga-ulume; Landolphia owariensis also known as ndene, makpodu or buma; Landolphia sp. amedede; Orthopichonia lacourtiana also known as makalasei, akale, akre, or mangocha; Saba comorensis also known as muhonga; Saba florida also known as ebeiye, mangocha or mapa; and Voacanga bracteata also known as uupo; fruits of the family Aquifoliaceae such as fruit of the Aquifoliaceae plant Dex mitis; fruits of the family Bignoniaceae such as fruit of the Bignoniaceae plant Kigelia Africana; fruits of the family Bombacaceae such as fruit of the Bombacaceae plant Adansonia digitata also known as muuyu; fruits of the family Boraginaceae such as fruit of the Boraginaceae plants Cordia africana and Cordia sinensis; fruits of the family Bursuraceae such as fruit of the Bursuraceae plants Canarium schweinfurthii also known as opi or mbe; and Commiphora Africana; fruits of the family Cactaceae such as fruit of the Cactaceae plant Opuntia vulgaris also known as mwatsa; fruits of the family Cannabaceae such as fruit of the Cannabaceae plant Trema orientalis; fruits of the family Capparaceae such as fruit of the Capparaceae plants Boscia mossambicensis and Boscia senegalensis; fruits of the family Celastraceae such as fruit of the Celastraceae plant Salacia pyriformioides also known as amambunombuno; fruits of the family Chrysobalanaceae such as fruit of the Chrysobalanaceae plants Parinari curatellifolia and Parinari excelsa; fruits of the family Curcurbitataceae such as fruit of the Curcurbitataceae plants Citrullus lanautus also known as tsamma melon or water melon; and Momordica sp. also known as bitter melon, balsam apple, koo or kou; fruits of the family Dichapetalaceae such as fruit of the Dichapetalaceae plant Dichapetalum zenkeri mtunduklula; fruits of the family Ebenaceae such as fruit of the Ebenaceae plant Diospyros austro-africanaalso known as jakkalsbos; Diospyros cornii also known as mukulu; Diospyros kirkii; Diospyros lycioides also known as bloubos; Diospyros mespiliformis; Diospyros natalensis also known as katsungwi-ka-tsakani; Diospyros squarrosa also known as mdzungu-muho; and Euclea divinorum; fruits of the family Euphorbiaceae such as fruit of the Eupliorbiaceae plants Bridelia cathartica also known as mkalakala; Bridelia micrantha; and Uapaca kirkiana; fruits of the family Fabaceae such as fruit of the Fabaceae plants Afzelia quanzensis; and Tamarindus indica; fruits of the family Fabaceae (Subf. Caesalpinioideae) such as fruit of the Fabaceae (Subf. Caesalpinioideae) plants Piliostigma reticulatum; and Tamarindus indica also known asmukwaju; fruits of the family Flacourtiaceae such as fruit of the Flacourtiaceae plant Flacourtia indica also known as munyondoya; fruits of the family Guttiferae such as fruit of the Guttiferae plants Garcinia livingstonei also known as mfidzofidzo; and Garcinia punctata also known as oro; fruits of the family Lamiaceae such as fruit of the Lamiaceae plants Hoslundia opposite also known as mjongolo; Vitex doniana; Vitex mombasse also known as mufudu-madzi; Vitex payos; and Vitex payos var payos also known as mufudu; fruits of the family Loganiaceae such as fruit of the Loganiaceae plants Strychnos cocculoides; and Strychnos innocua; fruits of the family Malvaceae such as fruit of the Malvaceae plants Azanza garckeana also known as morojwa; Grewia bicolor; Grewia plagiophylla also known as mukone; Grewia platyclada; Grewia villosa; and Thespesia danis also known as muhowe; fruits of the family Marantaceae such as fruit of the Marantaceae plant Thaumatococcus danellii also known as ngongo or manungu; fruits of the family Melastomataceae such as fruit of the Melastomataceae plant Dissotis sp. also known as ondekutukpa; fruits of the family Meliaceae such as fruit of the Meliaceae plant Carapa procera also known asmbolu or boru; fruits of the family Menispermaceae such as fruit of the Menispermaceae plant Dioscoreophyllum cumrninsii also known as kisombi; fruits of the family Moraceae such as fruit of the Moraceae plants Antiaris welwitschii also known as chonge or supa; Ficus sp. also known as Fig; Ficus sycomorus; Myrianthus arboreus also known as awaawa or mbombo; Myrianthus holstii also known as akawafefe or kawakawa; and Myrianthus preussii also known as akpekpe; fruits of the family Myrtacaceae such as fruit of the Myrtacaceae plants Psidium guajava also known as mapela or guava; Syzygium cordatum; and Syzygium guineense; fruits of the family Ochnaceae such as fruit of the Ochnaceae plants Ochna mossambicensis also known as mucherere; and Ouratea brunneopurpurea also known as mari; fruits of the family Olacaceae such as fruit of the Olacaceae plants Ximenia americana; Ximenia Americana also known as mutundukula; and Ximenia caffra; fruits of the family Oleacae such as fruit of the Oleacae plants Olea Africana also known as wild olive; and Olea europaca; fruits of the family Palmae such as fruit of the Palmae plants Elaeis guineensis also known as isa or oil palm; Hyphaene compressa also known as mukoma or mulala; Hyphaene thebaica also known as gingerbread palm; and Phoenix dactylifera also known as date palm; fruits of the family Piperaceae such as fruit of the Piperaceae plant Piper guineense also known as beka or kechu; fruits of the family Rhamnaceae such as fruit of the Rhamnaceae plants Berchemia discolor; Ziziphus mauritiana; and Ziziphus pubescens also known as mugogodera; fruits of the family Rosaceae such as fruit of the Rosaceae plants Rubus apetalus also known as kuamangongo; Rubus pinnatus var. afrotropicus also known as African blackberry or uangubegube; and Rubus sp. also known as Aggregte berries; fruits of the family Rubiaceae such as fruit of the Rubiaceae plants Heinsia crinita ssp. parviflora also known as mfyefye; Lamprothamnus zanguebaricus also known as mutosome; Polysphaeria parvifolia also known as mmangomango or mumangwi; Shelbournia bignoniiflora also known as tepe'eba or tepeububu; Shelbournia calycina also known as mulaki or ebakwasiko; Vangueria infausta also known as muviru; and Vangueria madagascariensis; fruits of the family Rutaceae such as fruit of the Rutaceae plants Citropsis articulata also known as fekekpa or amesalosalo; and Citrus sp. also known as ndimokocha or wild lemon; fruits of the family Salvadoraceae such as fruit of the Salvadoraceae plant Salvadora persica; fruits of the family Sapindaceae such as fruit of the Sapindaceae plants Deinbollia borbonica also known as mupalamwaka; Lecaniodiscus fraxinifolius also known as munyanyakanda; and Pancovia haimsiana also known as alelau or engango; fruits of the family Sapotaceae such as fruit of the Sapotaceae plants Autranella congolensis also known as mbanda; Gambeya africana also known as elinda or malinda; Gambeya lacourtiana also known as kiofe; Manilkara mochisia also known as munago; Manilkara sulcata also known as mutsedzi; Mimusops obtusifolia also known as mugama-muho; Mimuusops somaliensis also known as mugama; and Tieghemella africana also known as ifou, hou or fou; fruits of the family Solanaceae such as fruit of the Solanaceae plants Physalis minima also known as tunutunu; and Solanum incanum; fruits of the family Sterculiaceae such as fruit of the Sterculiaceae plants Cola lateritia also known as toko or ndoko and the otherwise unidentified Sterculiaceae plant known as kuka; fruits of the family Tecophilaeaceae such as fruit of the Tecophilaeaceae plant Cyanella hyacinthoides also known as raap or rapptol uintjie; fruits of the family Verbenaceae such as fruit of the Verbenaceae plant Lantana camara also known as mushomoro; fruits of the family Zingiberaceae such as fruit of the Zingiberaceae plants Aframomum laurentii also known as amekpi or matungulu; Aframomum sangiuneum also known as mbembe or matungulu; Aframomum sp. also known as kola; Aframomum stipulatum also known as ngemoa; and Renealmia Africana also known as ekoko; and fruits of the family Zygophyllaceae such as fruit of the Zygophyllaceae plant Balanites aegyptiaca.

Unrefined ancient seabed salt, mineral water and soil-based compounds are all included in diet protocols of the present invention and are available commercially or may be isolated from natural sources.

Soil-based compounds are recommended and included in a meal package. Soil-based compounds included according to embodiments of the present invention include clays, humic/fulvic acids, spore-forming bacteria, and dolomite.

Clays may take various forms, preferably from the smectite group, such as the calcium and sodium bentonites. Sources of humic/fulvic acid compounds include ancient European peat bogs, and soil extracted from the Fruitland Formation in the San Juan Basin of New Mexico in the United States. Spore-forming bacteria include species of the bacillus genus of spore formers that have seen extensive use in human supplements worldwide, such as B. subtilis, B. licheniformis, B. megaterium, B. clausii, B. coagulans, and B. laterosporus. When used as part of a heavy metal detoxification program, these soil-based compounds are most effective when the urine of the mammal is alkaline, which can be accomplished by, for example, ingesting mineral citrates and bicarbonates.

Specifically excluded from diet protocols provided in accordance with the present invention are those foods described as excluded in R. Mankovitz, The Wellness Project: A Rocket Scientist's Blueprint for Health, Montecito Wellness LLC, 2008, ISBN-13: 978-0980158458, illustratively including processed meats such as sausages and cured meats; dairy products such as milk, cream, butter and cheese; plant parts other than fruit illustratively including seeds, beans, nuts, tubers, roots, flowers and leaves; natural and artificial sugars other than those present in a naturally occurring food which passes the ABC TEST FOR FOOD™; vegetable oils extracted from the vegetable source; and liquids other than mineral/spring water.

In particular embodiments of the present invention, a Blueprint for Health diet package is provided which includes foods included in diet protocols of the present invention such as one or more organic free range grass-fed mea, one or more organic sweet fruits, unrefined ancient seabed salt, mineral water and soil-based compounds.

The package optionally includes a meal-size portion of an organic free range grass-fed meat, a meal-size portion of an organic sweet fruit, a meal-size portion of unrefined ancient seabed salt, a meal-size portion of mineral water and a meal-size portion of soil-based compounds. A meal-size portion of a particular food corresponds to conventional meal-size portions. For example, a meal-size portion of organic free range grass-fed meat ranges from about 3 ounces to about 1 pound, but can be more or less depending on the individual to be served. A meal-size portion of organic sweet fruit can be one whole or cut-up fruit or multiple fruits served individually or mixed together. A meal-size portion of organic sweet fruit ranges from about 1 ounce to about 1 pound depending on the individual to be served. A meal-size portion unrefined ancient seabed salt is similar to an amount of regular table salt, usually sodium chloride, consumed at a meal, typically in the range of about 0.1 gram to about 2.5 grams depending on the individual to be served. A meal-size portion of mineral water ranges from about 20 milliliters—about 2 liters depending on the individual to be served. A meal-size portion of soil-based compounds ranges from about 0.5 grams to about 100 grams depending on the individual to be served. A meal-size portion is optionally adjusted, for example, depending on the number of people to be served and/or the number of meals to be served.

Particular embodiments of methods of the present invention include diet and food choice protocols defined in the book R. Mankovitz, The Wellness Project: A Rocket Scientist's Blueprint for Health, Montecito Wellness LLC, 2008, ISBN-13: 978-0980158458, which is hereby incorporated by reference in its entirety.

Any patents or publications mentioned in this specification are incorporated herein by reference to the same extent as if each individual publication is specifically and individually indicated to be incorporated by reference.

The compositions and methods described herein are presently representative of preferred embodiments, exemplary, and not intended as limitations on the scope of the invention. Changes therein and other uses will occur to those skilled in the art. Such changes and other uses can be made without departing from the scope of the invention as set forth in the claims.

1. A method of promoting health, comprising:
providing a diet protocol to the public, the diet protocol comprising recommendation of foods low in synthetic and/or naturally occurring toxins which pass the Available Before Civilization Test requiring that the foods 1) are native to Africa; 2) require no human processing, including heating or cooking, to either gain access to, or digest or derive nutrition from the food in its natural form; 3) are not toxic if consumed raw; and 4) are not newly hybridized within the last 125,000 years or genetically modified.

2. The method of claim 1, wherein the diet protocol warns against consumption of processed meats, dairy products, plant seeds, beans, nuts, tubers, roots, flowers, leaves, purified sugar, artificial sweeteners, vegetable oils extracted from the vegetable source, and liquids other than mineral water and spring water.

3. The method of claim 1, wherein the foods which pass the Available Before Civilization Test are substantially free of protease inhibitors, lectins, glucosinolates, goitrogens, cyanogens, saponins, gossypol pigments, lathyrogens, carcinogens, and estrogen disruptors.

4. The method of claim 1, wherein the foods low in synthetic and/or naturally occurring toxins and passing the Available Before Civilization Test are organic free range grass-fed meat, organic sweet fruit, unrefined ancient seabed salt, mineral water and soil-based compounds.

5. The method of claim 4, wherein the meat is meat from an animal selected from the group consisting of: cattle, buffalo, sheep, pigs, antelope, goats, ostrich and hippopotamus.

6. The method of claim 1, wherein the foods low in synthetic and/or naturally occurring toxins and passing the Available Before Civilization Test comprise blood from an animal selected from the group consisting of: cattle, buffalo, sheep, pigs, antelope, goats, ostrich and hippopotamus.

7. The method of claim 1, wherein a food low in synthetic and/or naturally occurring toxins and passing the Available Before Civilization Test is pemmican.

8. The method of claim 1, wherein the diet protocol comprises recommendation of a diet package for consumption by a human comprising
a meal-size portion of an organic free range grass-fed meat;
a meal-size portion of an organic sweet fruit;
a meal-size portion of unrefined ancient seabed salt;
a meal-size portion of mineral water; and
a meal-size portion of one or more soil-based compounds.

9. The method of claim 4, wherein the soil-based compounds are clays, humic/fulvic acids, spore-forming bacteria, and dolomite.

10. The method of claim 8, wherein the one or more soil-based compounds are selected from the group consisting of: clays, humic/fulvic acids, spore-forming bacteria, and dolomite.

11. A diet package for consumption by a human, comprising:
an organic free range grass-fed meat, an organic sweet fruit, unrefined ancient seabed salt, mineral water and soil-based compounds.

12. The diet package of claim 11, wherein the diet package for consumption by a human comprises:
a meal-size portion of an organic free range grass-fed meat;
a meal-size portion of an organic sweet fruit;
a meal-size portion of unrefined ancient seabed salt;
a meal-size portion of mineral water; and
a meal-size portion of soil-based compounds.
